(19) United States
(12) Patent Application Publication
(10) Pub. No.: US 2012/0209800 A1
(43) Pub. Date: Aug. 16, 2012

(54) BUSINESS RULES

(75) Inventors: Tapas Kumar Nayak, Hyderabad (IN); Sai Shankar, Hyderabad (IN); Ravi Bollapragada, Hyderabad (IN); Sharad Agrawal, Hyderabad (IN); RaghuRam Nadiminti, Hyderabad (IN)

(73) Assignee: Microsoft Corporation, Redmond, WA (US)

(21) Appl. No.: 13/025,161

(22) Filed: Feb. 11, 2011

(51) Int. Cl. G06N 5/02

(52) U.S. Cl. 706/47; 706/60

(57) ABSTRACT

Aspects of the subject matter described herein relate to business rules. In aspects, an interface is described that allows a user to enter, update, and delete business rules. Once entered, the business rules may be validated and translated into other forms including a form that is executable by a computer system.

### BACKGROUND

A business may attempt to operate according to a set of rules. These rules may be formulated by business analysts who have little or no technical training. After formulating one or more business rules, a business analyst may provide documentation to a software developer to implement the rule(s) in a software program used by the business. The software developer may implement and test the rule(s) in the software program. Besides being time consuming, the above work flow may introduce errors as the rules go from business analyst to software developer.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY

Briefly, aspects of the subject matter described herein relate to business rules. In aspects, an interface is described that allows a user to enter, update, and delete business rules. Once entered, the business rules may be validated and translated into other forms including a form that is executable by a computer system.

This Summary is provided to briefly identify some aspects of the subject matter that is further described below in the Detailed Description. This Summary is not intended to identify key or essential features of the claimed subject matter, nor is it intended to be used to limit the scope of the claimed subject matter.

The phrase “subject matter described herein” refers to subject matter described in the Detailed Description unless the context clearly indicates otherwise. The term “aspects” is to be read as “at least one aspect.” Identifying aspects of the subject matter described in the Detailed Description is not intended to identify key or essential features of the claimed subject matter.

The aspects described above and other aspects of the subject matter described herein are illustrated by way of example and not limited in the accompanying figures in which like reference numerals indicate similar elements and in which:

### BRIEF DESCRIPTION OF THE DRAWINGS

FIG. 1 is a block diagram representing an exemplary general-purpose computing environment into which aspects of the subject matter described herein may be incorporated;

FIG. 2 is a block diagram that generally represents a system in accordance with aspects of the subject matter described herein;

FIG. 3 is a block diagram that generally represents an exemplary graphical interface that may facilitate creating, editing, maintaining, or otherwise specifying business rules;

FIG. 4 illustrates an exemplary decision table in accordance with aspects of the subject matter described herein;

FIG. 5 is a block diagram that generally represents an expression tree corresponding to an exemplary condition in accordance with aspects of the subject matter described herein;

FIG. 6 is a block diagram that generally represents an expression tree corresponding to an exemplary action in accordance with aspects of the subject matter described herein;

FIG. 7 is an exemplary formula that may be created to represent the decision table of FIG. 4 in accordance with aspects of the subject matter described herein; and

FIG. 8 is a flow diagram that generally represents exemplary actions that may occur in accordance with aspects of the subject matter described herein.

### DETAILED DESCRIPTION

### Definitions

As used herein, the term “includes” and its variants are to be read as open-ended terms that mean “includes, but is not limited to.” The term “or” is to be read as “and/or” unless the context clearly dictates otherwise. The term “based on” is to be read as “based at least in part on.” The terms “one embodiment” and “an embodiment” are to be read as “at least one embodiment.” The term “another embodiment” is to be read as “at least one other embodiment.”

As used herein, terms such as “a,” “an,” and “the” are inclusive of one or more of the indicated item or action. In particular, in the claims a reference to an item generally means at least one such item is present and a reference to an action means at least one instance of the action is performed.

Sometimes herein the terms “first”, “second”, “third” and so forth are used. The use of these terms in the claims is not intended to imply an ordering but is rather used for identification purposes. For example, the phrase “first version” and “second version” does not necessarily mean that the first version is the very first version or was created before the second version or even that the first version is requested or operated on before the second versions. Rather, these phrases are used to identify different versions.

Headings are for convenience only; information on a given topic may be found outside the section whose heading indicates that topic.

Other definitions, explicit and implicit, may be included below.

### Exemplary Operating Environment

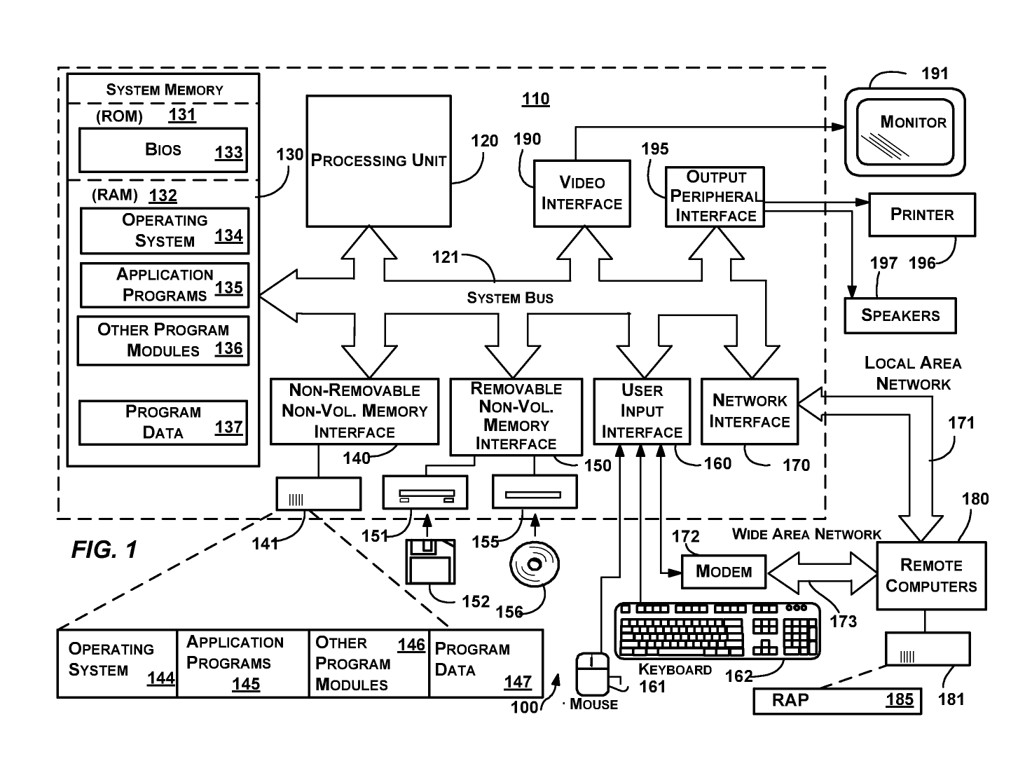

FIG. 1 illustrates an example of a suitable computing system environment 100 on which aspects of the subject matter described herein may be implemented. The computing system environment 100 is only one example of a suitable computing environment and is not intended to suggest any limitation as to the scope of use or functionality of aspects of the subject matter described herein. Neither should the computing environment 100 be interpreted as having any dependency or requirement relating to any one or combination of components illustrated in the exemplary operating environment 100.

Aspects of the subject matter described herein are operational with numerous other general purpose or special purpose computing system environments or configurations. Examples of well-known computing systems, environments, or configurations that may be suitable for use with aspects of the subject matter described herein comprise personal computers, server computers, hand-held or laptop devices, multiprocessor systems, microcontroller-based systems, set-top boxes, programmable consumer electronics, network PCs, minicomputers, mainframe computers, personal digital assistants (PDAs), gaming devices, printers, appliances including set-top, media center, or other appliances, automobile-embedded or attached computing devices, other mobile devices, distributed computing environments that include any of the above systems or devices, and the like.

Aspects of the subject matter described herein may be described in the general context of computer-executable instructions, such as program modules, being executed by a computer. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing aspects of the subject matter described herein includes a general-purpose computing device in the form of a computer 110. A computer may include any electronic device that is capable of executing an instruction. Components of the computer 110 may include a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus also known as Mezzanine bus, Peripheral Component Interconnect Extended (PCI-X) bus, Advanced Graphics Port (AGP), and PCI express (PCIe).

The computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media.

Computer storage media includes both volatile and nonvolatile, removable and non-removable media implemented in any method or technology for storage of information such as computer-readable instructions, data structures, program modules, or other data. Computer storage media includes RAM, ROM, EEPROM, flash memory or other memory technology, CD-ROM, digital versatile discs (DVDs) or other optical disk storage, magnetic cassettes, magnetic tape, magnetic disk storage or other magnetic storage devices, or any other medium which can be used to store the desired information and which can be accessed by the computer 110.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct wired connection, and wireless media such as acoustic, RF, infrared and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disc drive 155 that reads from or writes to a removable, nonvolatile optical disc 156 such as a CD ROM or other optical media. Other removable/non-removable, volatile/nonvolatile computer storage media that can be used in the exemplary operating environment include magnetic tape cassettes, flash memory cards, digital versatile discs, other optical discs, digital video tape, solid state RAM, solid state ROM, and the like. The hard disk drive 141 may be connected to the system bus 121 through the interface 140, and magnetic disk drive 151 and optical disc drive 155 may be connected to the system bus 121 by an interface for removable non-volatile memory such as the interface 150.

The drives and their associated computer storage media, discussed above and illustrated in FIG. 1, provide storage of computer-readable instructions, data structures, program modules, and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies.

A user may enter commands and information into the computer 110 through input devices such as a keyboard 162 and pointing device 161, commonly referred to as a mouse, trackball, or touch pad. Other input devices (not shown) may include a microphone, joystick, game pad, satellite dish, scanner, a touch-sensitive screen, a writing tablet, or the like. These and other input devices are often connected to the processing unit 120 through a user input interface 160 that is coupled to the system bus, but may be connected by other interface and bus structures, such as a parallel port, game port or a universal serial bus (USB).

A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets, and the Internet.

When used in a LAN networking environment, the computer 110 is connected to the LAN 171 through a network interface or adapter 170. When used in a WAN networking environment, the computer 110 may include a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

### Rules

As mentioned previously, software may be developed that implements business rules. A business rule may be thought of as a statement that defines or constrains some aspect of a business. A business rule may be intended to assert structure or to control or influence the behavior of a business. Business rules may define the “what” aspect of a business system without defining how the system is built and run to solve a business process.

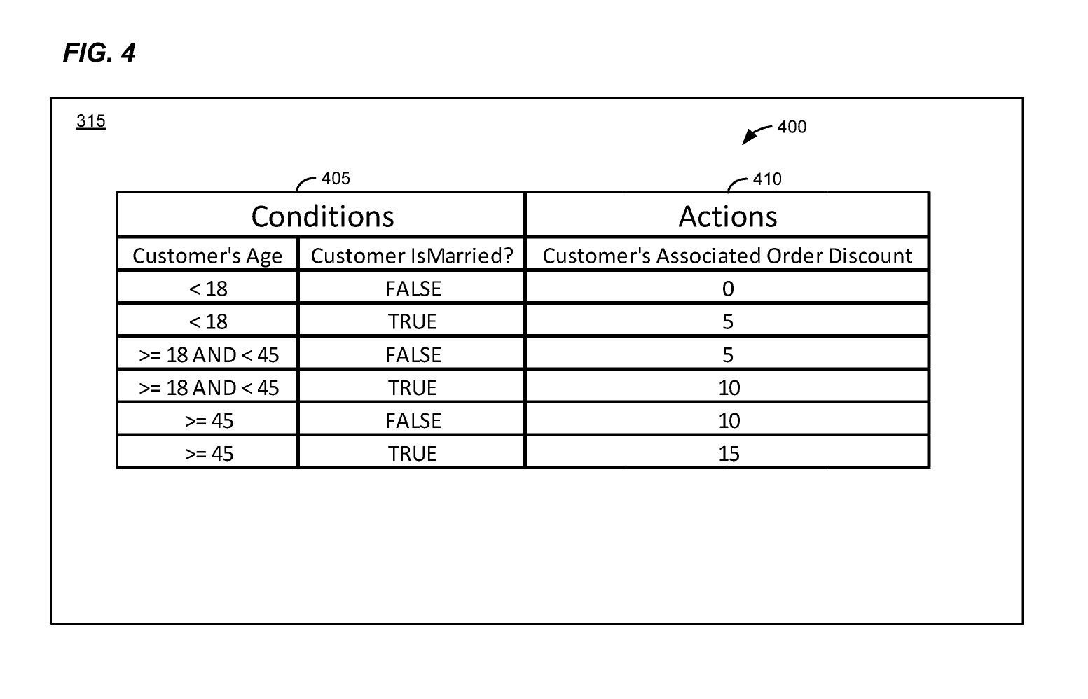

As one example, a business rule may specify whether a bank officer is allowed to provide a loan based on certain conditions regarding the loan. For example, if the person seeking the loan is less than 18 years old, a business rule may indicate that a loan may not be extended to the person. An example that illustrates other business rules is discussed in conjunction with FIG. 4 below.

Although the term “business” is sometimes used herein, aspects of the subject described herein may also be applied to other types of organizations including entities that are not businesses. Indeed the phrase “business rule” is to be interpreted to apply to any type of organization whether the organization is a business or not a business.

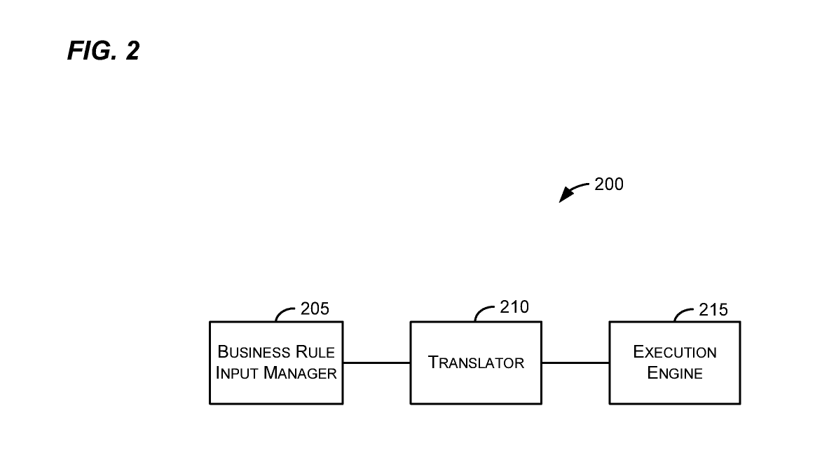

FIG. 2 is a block diagram that generally represents a system in accordance with aspects of the subject matter described herein. The system 200 may include a business rule input manager 205, a translator 210, an execution engine 215, and may also include other components (not shown).

The business rule input manager 205, translator 210, and execution engine 215 may be implemented on one or more one or more computing devices. Such devices may include, for example, personal computers, server computers, hand-held or laptop devices, multiprocessor systems, microcontroller-based systems, set-top boxes, programmable consumer electronics, network PCs, minicomputers, mainframe computers, cell phones, personal digital assistants (PDAs), gaming devices, printers, appliances including set-top, media center, or other appliances, automobile-embedded or attached computing devices, other mobile devices, distributed computing environments that include any of the above systems or devices, and the like. An exemplary device that may be configured to act one or more of the business rule input manager 205, translator 210, and execution engine 215 comprises the computer 110 of FIG. 1.

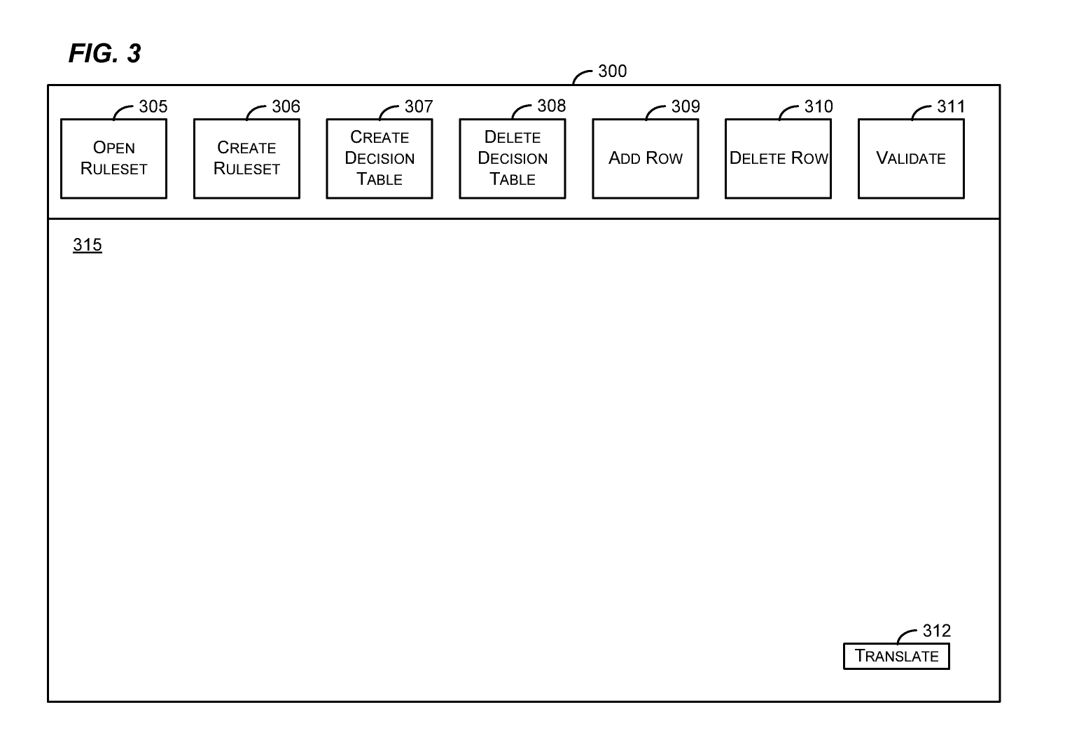

The business rule input manager 205 may include one or more components that may operate to facilitate entering, displaying, saving, retrieving, editing, deleting, organizing, validating, and/or performing other actions with respect to business rules. For example, in one embodiment, the business rule input manager 205 may implement a graphical interface as illustrated in FIG. 3. The business rule input manager 205 may receive input regarding business rules and may update a data structure that represents the business rules with one or more conditions and one or more actions as indicated by the input.

As used herein, the term component is to be read to include hardware such as all or a portion of a device, a collection of one or more software modules or portions thereof, some combination of one or more software modules or portions thereof and one or more devices or portions thereof, and the like.

FIG. 3 is a block diagram that generally represents an exemplary graphical interface that may facilitate creating, editing, maintaining, or otherwise specifying business rules. The graphical interface 300 may be hosted by the business rule input manager 205 of FIG. 2. The graphical interface 300 may include buttons 305-312 (or other graphical interface elements), other buttons (now shown) and a workspace 315. The button 305 may allow a user to open an existing set of rules (sometimes called a rule set) from a repository such as a database. A rule set may include one or more business rules.

The button 306 may allow the user to create a new rule set. A rule set may be represented by one or more decision tables. A decision table is an abstraction of the conditions and actions associated with those conditions.

FIG. 4 illustrates an exemplary decision table in accordance with aspects of the subject matter described herein. The decision table 400 includes one or more conditions 405 and one or more actions 410. Each row of the decision table 400 may associate one or more conditions with one or more actions.

An action may include a value (e.g., discount amount, decision, text based instruction, or the like), may trigger an event, may cause something such as an e-mail to be sent, or the like.

In the example illustrated in FIG. 4, customers may be given different discounts depending on conditions regarding the customers. In particular, based on the customer's age and whether the customer is married, the customer may be given a discount (e.g., the action).

Although as illustrated, each row of the decision table 400 associates one action with a set of conditions, in other embodiments, a row of a decision table may associate multiple actions with one or more conditions.

Returning to FIG. 3, the button 307 may allow a user to create a decision table to be added to a rule set. In response to activating the button 307, a workspace similar to the workspace 315 may be opened and a user may able to define a decision table such as shown in FIG. 4.

The button 308 may allow a user to delete a decision table from a rule set. The button 309 may allow a user to add a row to a decision table while the button 310 may allow a user to delete a row from a decision table.

The button 311 may be used to perform validation on a rule set. Some exemplary validation that may be performed include:
1. Is the rule set syntactically correct?

2. For decision tables within the rule set, do the fields include permissible values? For example, a validation check may be performed to determine whether a TRUE/FALSE field of the decision table includes only true or false values.

3. Are the rules deterministic? In other words, does a set of conditions map to one and only one set of one or more actions. For example, a decision table like table 400 illustrated in FIG. 4 may not pass validation if two rows of the table have the exact same conditions only while having different actions. For example, if the first row includes the conditions that the customer's age is less than 18 and the customer is not married and the second row also includes those same conditions, the decision table may not pass validation as two different discounts may be associated with the same set of conditions.

4. Are there gaps in the conditions? For example, if the customer's age in the decision table of table 400 did not provide conditions for ages greater than or equal to 45, what discount to give customers with ages greater than or equal to 45 would be undefined. This undefined behavior may be undesirable in some implementations and may be checked for during validation.

5. Are conditions and assignments made on similar types? For example, the two conditions in “IF (Customer's Age>‘abcd’) OR (Customer's Age=Dec. 20, 1986)” do not refer to the same type and are hence incorrect.

The above examples of validation that may be performed are not intended to be all-inclusive or exhaustive. Indeed, based on the teachings herein, those skilled in the art may recognize many other validation checks that may be performed without departing from the spirit or scope of aspects of the subject matter described herein.

The button 312 may be used to receive input indicative of a command to translate a decision table into a form executable by a computer system. Upon activation of the button 312, the rule set may be translated into an executable form (e.g., such as an expression tree, code, or the like), a formula, or some other representation.

Some additional exemplary buttons that may be included in the graphical interface 300 include an open repository button, a what-if analysis button, a refresh button, a publish button, and the like. An open repository button may be used to open a database that includes one or more rule sets.

A what-if analysis button may allow a user to determine the actions associated with particular conditions. While this may be determined by inspection in some decision tables such as the decision table 400 of FIG. 4, for more complicated rule sets, the actions for a given set of conditions may be more difficult to determine by inspection. Activating the what-if analysis button may cause a user interface to display an element (such as a dialog box, form, or the like) that allows the user to enter conditions and see actions associated with the conditions.

The what-if analysis may also allow a user to test the business rules against data including user input data, simulated data, historical data, and the like.

A publish button may allow a user to save a rule to a repository. The publish button may also allow a user to indicate a time window during which the rules are active. In one implementation, the publish button and the translate button 312 may be combined such that activating the publish button causes translation to occur in conjunction with saving the rule to the repository.

The graphical interface 300 may also provide other user interface elements. For example, the graphical interface 300 may display a resources element that shows a layout of a database of a repository that includes one or more rule sets. The layout may be organized in a hierarchical manner and may include elements that allow the hierarchy to be expanded or collapsed.

As another example, the graphical interface 300 may display a properties element that includes properties about a rule set. Some exemplary properties include author, date of creation, edit date, the name of the business object model associated with the rule set, and the like.

As another example, the graphical interface 300 may display a terms and vocabulary element. This element may include a mechanism for viewing the business object model associated with the rule set. For example, this element may allow a user to find entities, associations, properties, and other characteristics of a business object model. The terms and vocabulary element may be thought of as data that defines objects in the object model. For example, a loan object model may be defined as properties of a customer seeking the loan (e.g., name age, marital status, net worth, and the like), properties of the loan (e.g., loan amount, interest rate, payback period, and the like), properties of the bank manager in charge of the loan, other properties, and the like.

The examples above of additional user interface elements that may be included on the graphical interface 300 are not intended to be all-inclusive or exhaustive. Fewer, more, or other user interface elements may be included in the graphical interface 300 without departing from the spirit or scope of aspects of the subject matter described herein.

The graphical interface 300 may be implemented by a plug-in to a spreadsheet or other program. As known by those skilled in the art, a spreadsheet allows, among other things, a user to enter data into cells and perform calculations on the data based on formulas. A plug-in may include one or more components that add specific capabilities to a larger software application.

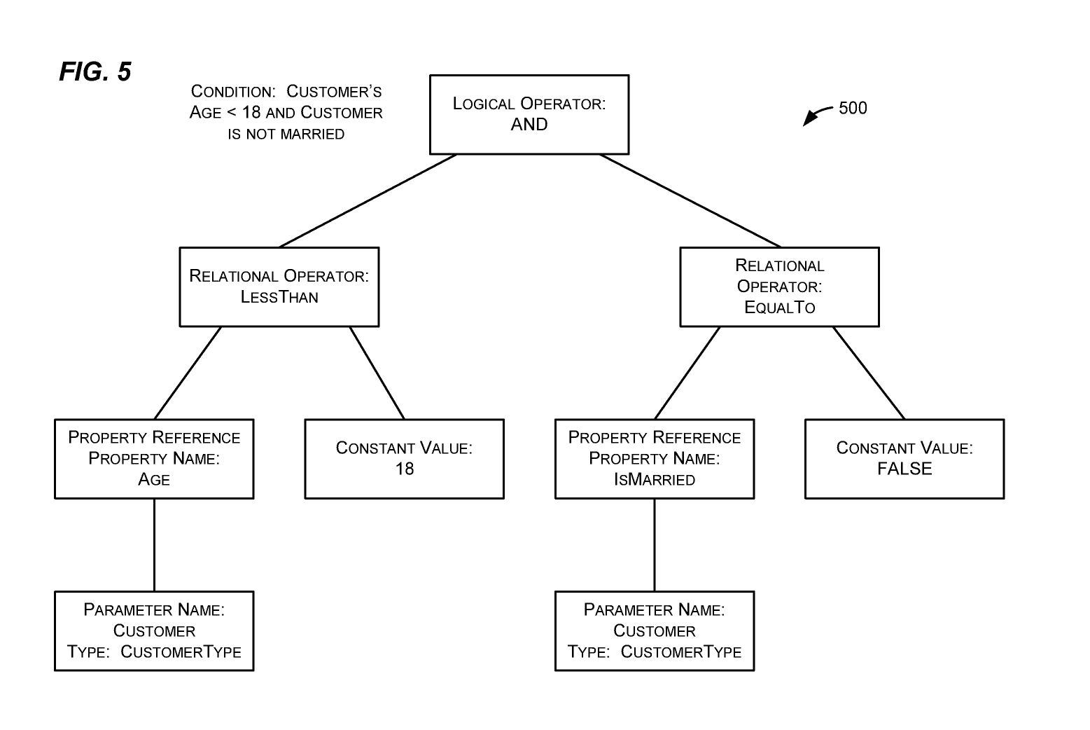

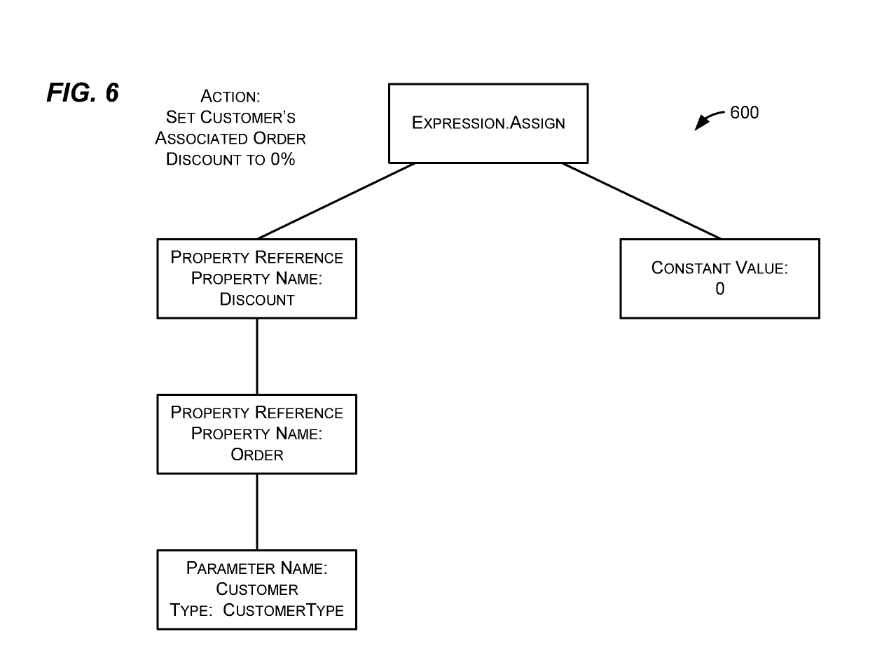

Returning to FIG. 2, once a rule set has been defined, the translator 210 may convert the rule set into a form that can be executed by the execution engine 215. For example, the execution engine 215 may have the capability of executing expression trees such as the exemplary expression trees illustrated in FIGS. 5 and 6. To create an expression tree, the translator 210 may derive the expression tree from the data structure created by the business rule input manager 205. The expression tree may encode any conditions included in the business rule as described in more detail below.

In one embodiment, each row in a decision table translates to a single rule in a rule set. Each column in the conditions group translates to a single expression. Multiple columns in the condition group are then AND'ed (logical conjunction) together to form a composite condition expression.

FIG. 5 is a block diagram that generally represents an expression tree corresponding to an exemplary condition in accordance with aspects of the subject matter described herein. The expression tree 500 corresponds to the condition: Customer's Age<18 and Customer is not married.

FIG. 6 is a block diagram that generally represents an expression tree corresponding to an exemplary action in accordance with aspects of the subject matter described herein. The action 600 of setting the discount to 0% represented in FIG. 6 may be associated with the condition 500 represented in FIG. 5. An action column in a decision table may be translated to an assignment statement. For example, the action column in the first row for the decision table 400 of FIG. 4 may be translated to the expression tree of FIG. 6.

Returning to FIG. 2, in one embodiment, the translator 210 may translate rules into .NET code for use in the .NET framework produced by Microsoft Corporation of Redmond, Wash. For example, the translator 210 may translate the rule represented in FIG. 5 into the following exemplary .NET code:

Expression.AndAlso(

Expression.MakeBinary(

ExpressionType.LessThan,
Expression.PropertyOrField(

Expression.Parameter(typeof(Customer), “Customer”),
“Age”),

Expression.Constant(18)),

Expression.MakeBinary(

ExpressionType.Equal,
Expression.PropertyOrField(

Expression.Parameter(typeof(Customer), “Customer”),
“IsMarried”),

Expression.Constant(false)))

Other rules represented in the decision table 400 of FIG. 4 may be translated in a similar manner into .NET code. In this embodiment, the execution engine 215 may comprise one or more of the .NET framework components.

Alternatively, or in addition, rules may be translated into a query language. One exemplary query language into which rules may be translated includes the Language Integrated Query (LINQ) language produced by Microsoft Corporation of Redmond, Wash.

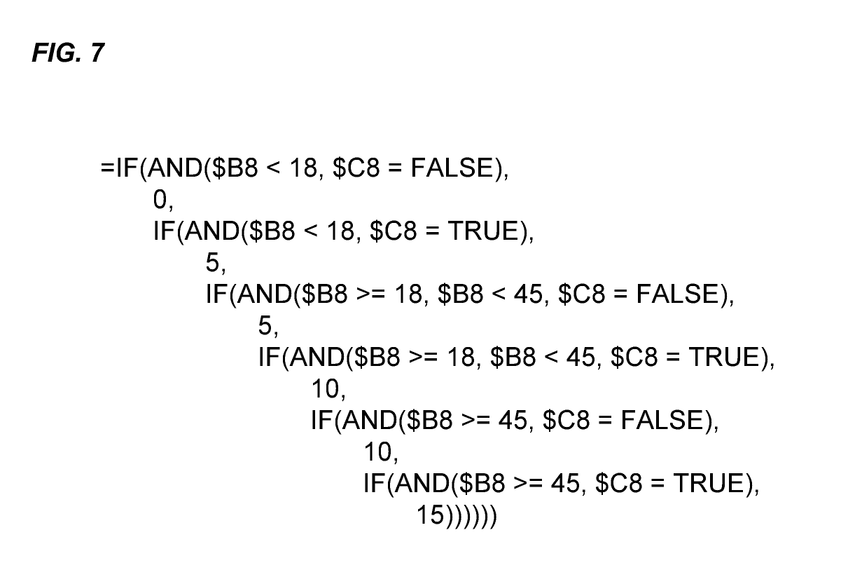

The translator 210 may have the capability of translating a rule set into another form such as a formula of a spreadsheet. For example, the translator 210 may have the capability of translating the rule set represented by the decision table 400 of FIG. 4 into the exemplary formula illustrated in FIG. 7. This formula may be parsed to create an expression tree for execution by the execution engine 215.

In some implementations, the business rule input manager 205 may receive input that defines business rules in the form of formulas. This may be more suitable, for example, for users who are well versed in spreadsheet or other formulas.

The translator 210 may also have the capability of translating a formula into a decision table. For example, the translator 210 may translate the formula of FIG. 7 into the decision table 400 of FIG. 4. This may be helpful, for example, to assist in human understanding for domain experts that are more familiar with decision tables than with spreadsheet formulas.

One or more actions may also be represented by a formula that depends on one or more variables. An action may be constant or depend on certain variables such as the customer's age. For example, a discount action may be formulated as a formula that uses the customer's age as an independent variable (e.g., discount=5+0.2*age).

The translator 210 may also convert a rule set into a form that is easier to understand for some users such as a flow chart. This translation may be done directly from the decision table, from a formula derived from the decision table, or in another manner without departing from the spirit or scope of aspects of the subject matter described herein.

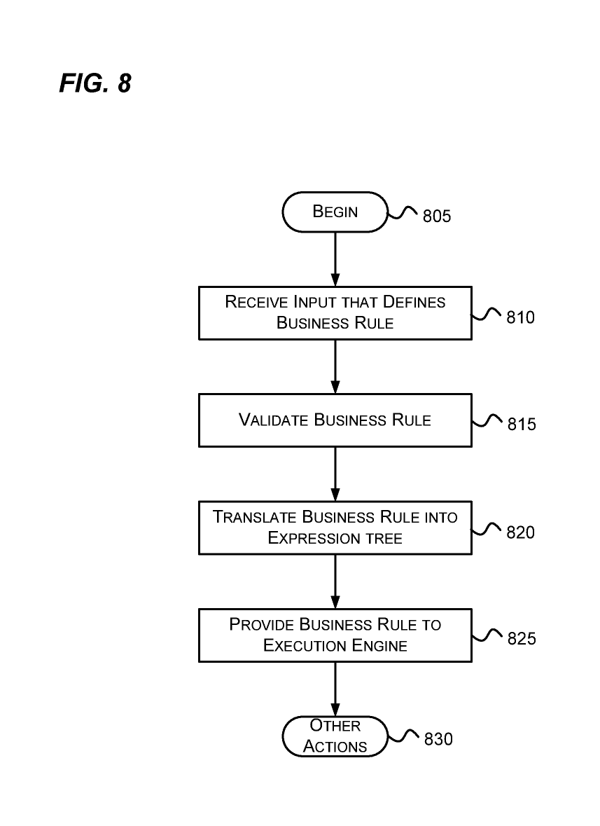

FIG. 8 is a flow diagram that generally represents exemplary actions that may occur in accordance with aspects of the subject matter described herein. For simplicity of explanation, the methodology described in conjunction with FIG. 8 is depicted and described as a series of acts. It is to be understood and appreciated that aspects of the subject matter described herein are not limited by the acts illustrated and/or by the order of acts. In one embodiment, the acts occur in an order as described below. In other embodiments, however, the acts may occur in parallel, in another order, and/or with other acts not presented and described herein. Furthermore, not all illustrated acts may be required to implement the methodology in accordance with aspects of the subject matter described herein. In addition, those skilled in the art will understand and appreciate that the methodology could alternatively be represented as a series of interrelated states via a state diagram or as events.

Turning to FIG. 8, at block 805, the actions begin. At block 810, input is received that defines a business rule. This input may be received via a user interface of a computer. For example, referring to FIGS. 2 and 4, the business rule input manager 205 may receive input that fills out the decision table 405. As one example, receiving input may include receiving input into cells of a spreadsheet wherein the input defines one or more conditions and one or more actions of the business rule.

As another example, receiving input may include receiving a formula in a cell of a spreadsheet where the formula defines the business rule by including one or more conditions and one or more actions associated with the one or more conditions.

At block 815, the business rules are validated. For example, referring to FIGS. 2 and 4, the business rule input manager 205 may perform validation checks on the decision table 405. As mentioned previously, some exemplary validation checks include: determining if the business rule is syntactically correct, determining whether fields of a decision table include permissible values, determining if each rule within a rule set that includes the business rule is deterministic, determining if there are gaps in conditions of the rule set, and determining if conditions and assignments of the business rule are made on similar types.

At block 820, the business rule is translated into an expression tree. For example, referring to FIGS. 2, and 4-6, the translator 210 may translate the first row of the decision table into the expression tree 500 and the expression tree 600.

At block 825, the business rule is provided to an execution engine. For example, referring to FIG. 2, the translator 210 may send an expression tree or data equivalent to or derived from the expression tree to the execution engine 215 for use by the execution engine 215 in enforcing a business rule.

At block 830, other actions, if any, may be performed.

As can be seen from the foregoing detailed description, aspects have been described related to business rules. While aspects of the subject matter described herein are susceptible to various modifications and alternative constructions, certain illustrated embodiments thereof are shown in the drawings and have been described above in detail. It should be understood, however, that there is no intention to limit aspects of the claimed subject matter to the specific forms disclosed, but on the contrary, the intention is to cover all modifications, alternative constructions, and equivalents falling within the spirit and scope of various aspects of the subject matter described herein.

What is claimed is:

1. A method implemented at least in part by a computer, the method comprising:
via a user interface of the computer, receiving input that defines a business rule;
translating the business rule into an expression tree; and
providing the expression tree to an execution engine for executing the business rule.

2. The method of claim 1, wherein receiving input that defines a business rule comprises receiving input into cells of a spreadsheet, the input defining one or more conditions and one or more actions of the business rule.

3. The method of claim 1, wherein receiving input that defines a business rule comprises receiving a formula in a cell of a spreadsheet, the formula defining the business rule by including one or more conditions and one or more actions associated with the one or more conditions.

4. The method of claim 1, wherein receiving input that defines a business rule comprises receiving input in a decision table of the user interface.

5. The method of claim 4, wherein translating the business rule into an expression tree comprises translating the decision table into a single spreadsheet formula prior to translating the formula into the expression tree.

6. The method of claim 1, further comprising validating the business rule prior to providing the expression tree to the execution engine.

7. The method of claim 6, wherein validating the business rule includes one or more of determining if the business rule is syntactically correct, determining whether fields of a decision table include permissible values, determining if each rule within a rule set that includes the business rule is deterministic, determining if there are gaps in conditions of the rule set, and determining if conditions and assignments of the business rule are made on similar types.

8. In a computing environment, a system, comprising:
a business rule input manager operable to receive input regarding a business rule and to update a data structure that represents the business rule with one or more conditions and one or more actions as indicated by the input;
a translator operable to create an expression tree derived from the data structure, the expression tree encoding any conditions included in the business rule; and
an execution engine operable to use the expression tree to execute the business rule.

9. The system of claim 8, wherein the business rule input manager comprises a plug-in for a spreadsheet, the business rule input manager being operable receiving the input from the spreadsheet.

10. The system of claim 8, wherein the business rule input manager is operable to display user interface elements including at least an open rule set element, a create rule set element, a create decision table element, a delete decision table element, an add row element, a delete row element, and a validate element.

11. The system of claim 8, wherein the business rule input manager is operable to receive input regarding a business rule by being operable to receive the input via a decision table.

12. The system of claim 8, wherein the business rule input manager is operable to receive input regarding a business rule by being operable to receive the input via a formula that defines the business rule.

13. The system of claim 8, wherein the translator being operable to create an expression tree derived from the data structure comprises the translator being operable to create a formula that encodes the business rule and to create the expression tree from the formula.

14. The system of claim 13, wherein the formula comprises a spreadsheet formula.

15. The system of claim 8, wherein the translator being operable to create an expression tree from a data structure comprises the translator being operable to create the expression tree from a decision table by translating each row in the decision table into a single rule of a rule set.

16. The system of claim 15, wherein the translator being operable to translate a row in the decision table to a single rule of the rule set comprises the translator being operable to translate each condition column of the row into a corresponding single expression and to logically AND expressions created therefrom together to form a composite expression.

17. The system of claim 15, wherein the translator being operable to translate a row in the decision table to a single rule of the rule set comprises the translator being operable to translate each action column of the row into a corresponding action expression.

18. In a computer system, a graphical interface, comprising:
a graphical interface element operable to receive input into a decision table representing a rule set;
a graphical interface element operable to receive input indicative of a command to add a row to the decision table;
a graphical interface element operable to receive input indicative of a command to validate the rule set; and
a graphical interface element operable to receive input indicative of a command to translate the decision table into a form executable by the computer system.

19. The graphical interface of claim 18, further comprising:
a graphical interface element operable to receive a command to open the rule set from a repository; and
a graphical interface element operable to indicate a command to publish the rule set to the repository.

20. The graphical interface of claim 18, further comprising a graphical interface element operable to receive input indicative of a command to translate the decision table into a single formula.
